(19) United States
(12) Patent Application Publication
(10) Pub. No.: US 2026/0257129 A1
(43) Pub. Date: Sep. 3, 2026

(54) COMPUTER IMPLEMENTED METHOD, ONE OR MORE NON-TRANSITORY COMPUTER-READABLE STORAGE MEDIUM, AND GAME SYSTEM

(71) Applicant: NINTENDO CO., LTD., Kyoto-shi (JP)

(72) Inventor: Yuki ONOZAWA, Kyoto (JP)

(21) Appl. No.: 19/655,068

(22) Filed: Apr. 22, 2026

Related U.S. Application Data
(63) Continuation of application No. PCT/JP2023/039741, filed on Nov. 2, 2023.

(51) Int. Cl. A63F 13/211; A63F 13/5372

(52) U.S. Cl. CPC A63F 13/211; A63F 13/5372

(57) ABSTRACT

A first object is moved on a virtual surface, based on first data outputted in accordance with movement of a first mouse on a surface, the first object is rotated based on second data outputted in accordance with rotation of the first mouse, a second object is moved on the virtual surface, based on third data outputted in accordance with movement of a second mouse on the surface, and the second object is rotated based on fourth data outputted in accordance with rotation of the second mouse. A first process is executed based on an intersection point where the direction in which the first object is oriented and a direction in which the second object is oriented intersect.

### CROSS REFERENCE TO RELATED APPLICATION

This application is a continuation of International Application No. PCT/JP2023/039741, filed on November 2, 2023, the entire contents of which are incorporated herein by reference.

### FIELD

The present disclosure relates to information processing for controlling a virtual object, based on data outputted from a mouse.

### BACKGROUND AND SUMMARY

Hitherto, game processing using a mouse has been known.

In the above technology, there is room to provide a novel game having new operability and game characteristics using a mouse.

In view of the above circumstances, for example, configuration examples are given below.

### Configuration 1

A configuration 1 is directed to a game processing method performed using an information processing apparatus including a processor, that is, the configuration 1 is directed to a computer-implemented method, including: moving a first object on a virtual surface in a virtual space, based on first data outputted in accordance with movement of a first mouse on a surface; rotating the first object, based on second data outputted in accordance with rotation of the first mouse; moving a second object on the virtual surface in the virtual space, based on third data outputted in accordance with movement of a second mouse on the surface; rotating the second object, based on fourth data outputted in accordance with rotation of the second mouse; and executing a first process, based on an intersection point where a direction in which the first object is oriented and a direction in which the second object is oriented intersect.

According to the above configuration example, a novel game utilizing the intersection of the orientations of the first mouse and the second mouse can be provided. For example, a game that offers a novel operational feel of adjusting the positions and orientations of the mice with both hands can be provided.

### Configuration 2

In a configuration 2 based on the above configuration 1, the first process may be a process based on a triangle region formed, on the virtual surface, from a position of the first object, a position of the second object, and the intersection point.

According to the above configuration example, a novel game utilizing the triangle region can be provided. Also, it is possible to provide a gaming experience that requires considering the positions of the first object itself and the second object itself, in addition to the position of intersection of the directions in which the first object and the second object are oriented, thus enhancing the entertainment characteristics of the game.

### Configuration 3

In a configuration 3 based on the above configuration 2, the first process may be a process of providing a first effect serving as an in-game advantageous effect in the triangle region.

According to the above configuration example, motivation for actively creating the triangle region can be provided.

### Configuration 4

In a configuration 4 based on the above configuration 3, the method may include moving a third object on the virtual surface, and the first effect may be an effect on the third object in a state of being contained in the triangle region.

According to the above configuration example, a game characteristic that involves enclosing the moving third object by using the triangle region can be provided.

### Configuration 5

In a configuration 5 based on the above configuration 4, when the first object or the second object and the third object are in a specified positional relationship, a second process of providing a second effect serving as an in-game disadvantageous effect may be executed.

According to the above configuration example, a game characteristic that involves creating the triangle region by moving the first object and the second object while avoiding collision with the third object can be provided, thus enhancing the entertainment characteristics of the game.

### Configuration 6

In a configuration 6 based on the above configuration 4 or 5, in the first process, an effect amount of the first effect may increase as a time during which the third object is contained in the triangle region increases.

According to the above configuration example, it is possible to provide a gaming experience of operating two mice to maintain the state where the third object is contained within the triangle region, thus enhancing the entertainment characteristics of the game.

### Configuration 7

In a configuration 7 based on the above configuration 5, in the first process, the effect amount of the first effect may increase as an area of the triangle decreases.

According to the above configuration example, it is necessary to further approach the third object in order to reduce the area of the triangle so as to achieve a significant effect. Thus, when the third object is an enemy character, for example, the risk of receiving damage increases, making it possible to provide a tense gaming experience. Therefore, the entertainment characteristics of the game are enhanced.

### Configuration 8

In a configuration 8 based on any one of the above configurations 1 to 7, a third process of providing a third effect serving as an in-game advantageous effect on a straight line connecting the first object and the second object may be executed.

According to the above configuration example, it is possible to make players aware of the positional relationship (positioning) between the first object and the second object, thus enhancing the entertainment characteristics of the game.

### Configuration 9

In a configuration 9 based on any one of the above configurations 2 to 8, a fourth process of providing a fourth effect serving as an in-game advantageous effect at the intersection point may be executed.

According to the above configuration example, since the advantageous effect can be generated at the intersection point, a strategic characteristic that involves encouraging a user to consider where to position the intersection point is added to the game, thus enhancing the entertainment characteristics.

### Configuration 10

In a configuration 10 based on the above configuration 1, the first process may be a process of providing a fifth effect serving as an in-game advantageous effect at the intersection point.

According to the above configuration example, it is possible to provide a novel game utilizing the operations that involve causing the direction in which the first object is oriented and the direction in which the second object is oriented to intersect.

Each configuration example described above may be applied to a game system, a game apparatus, and one or more non-transitory computer-readable storage media having stored therein a game program.

### BRIEF DESCRIPTION OF THE DRAWINGS

FIG. 1 is a block diagram showing a non-limiting example of the hardware configuration of an information processing apparatus 2;

FIG. 2 shows a non-limiting example of the appearance of a mouse 40;

FIG. 3 illustrates a non-limiting example of an operation of the mouse 40;

FIG. 4 shows a non-limiting example of a game screen for the game processing assumed in the exemplary embodiment;

FIG. 5 shows a non-limiting example of the attitude of the mouse;

FIG. 6 shows a non-limiting example of the attitude of the mouse;

FIG. 7 shows a non-limiting example of a game screen for the game processing assumed in the exemplary embodiment;

FIG. 8 shows a non-limiting example of various data stored in a storage unit 22 of the information processing apparatus 2;

FIG. 9 is a non-limiting example of a flowchart showing the details of the game processing;

FIG. 10 shows a non-limiting example of a game screen according to a first example;

FIG. 11 illustrates a non-limiting example of a mouse operation;

FIG. 12 shows a non-limiting example of the game screen according to the first example;

FIG. 13 shows a non-limiting example of the game screen according to a second example; and

FIG. 14 shows a non-limiting example of the game screen according to the second example.

### DETAILED DESCRIPTION OF NON-LIMITING EXAMPLE EMBODIMENTS

Hereinafter, an exemplary embodiment will be described.

### Hardware configuration of information processing apparatus 2

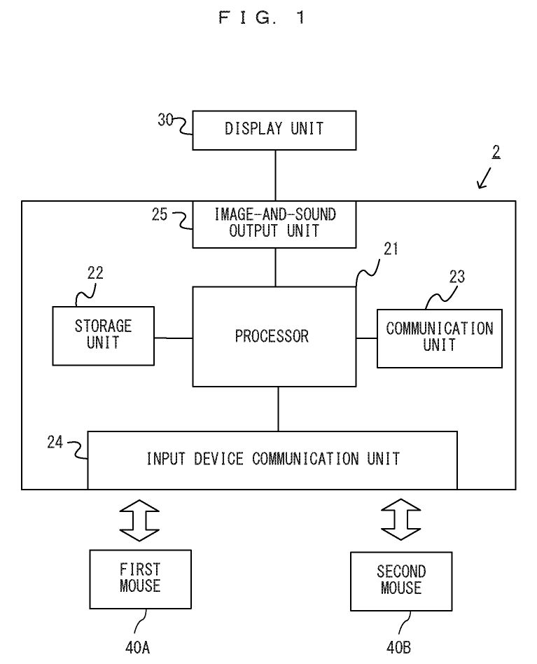

FIG. 1 is a block diagram showing an example of the hardware configuration of an information processing apparatus 2 according to the exemplary embodiment. In FIG. 1, the information processing apparatus 2 includes a processor 21. The processor 21 is an information processing unit for executing various kinds of information processing executed in the information processing apparatus 2. In the exemplary embodiment, the processor 21 is composed of a SoC (System-on-a-chip) having at least a CPU (Central Processing Unit) function and a GPU (Graphics Processing Unit) function. In another exemplary embodiment, the CPU and the GPU may be configured separately. The processor 21 executes an information processing program (e.g., a game program) stored in the storage unit 22, thereby executing various types of information processing. The storage unit 22 may be, for example, an internal storage medium such as a flash memory or a dynamic random-access memory (DRAM) or may be configured to utilize an external storage medium attached to a slot (not shown), or the like. The information processing apparatus may be, for example, a game apparatus, a personal computer, or a server.

The information processing apparatus 2 includes a communication unit 23 for communicating with other information processing apparatuses or a specified server.

The information processing apparatus 2 includes an input device communication unit 24 for performing wired or wireless communication between the information processing apparatus 2 and various input devices. In the exemplary embodiment, as an example of an input device, an example using two mice, namely a first mouse 40A and a second mouse 40B (which may be collectively referred to simply as mouse, hereinafter), will be described.

A display unit 30 (e.g., a monitor, etc.) is connected to the information processing apparatus 2 via an image-and-sound output unit 25. For example, the processor 21 outputs an image and a sound generated through execution of the above-described information processing, to the display unit 30 via the image-and-sound output unit 25.

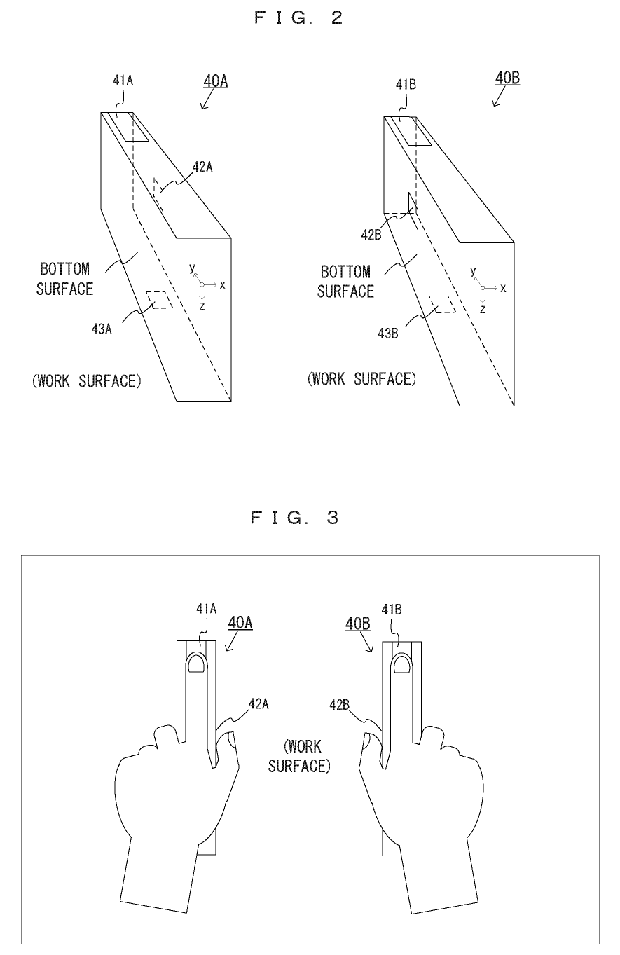

FIG. 2 is a schematic diagram showing an example of the appearance of the first mouse 40A and the second mouse 40B. As shown in FIG. 2, the first mouse 40A and the second mouse 40B each have a plate shape in which the y-axis direction is the longitudinal direction (a rectangular parallelepiped or a similar shape in which the thickness in the x-axis direction is smaller than the thickness in the y-axis direction and the thickness in the z-axis direction, and the thickness in the z-axis direction is smaller than the thickness in the y-axis direction), and the mice have the same size.

The first mouse 40A includes a sensor (which may be referred to as "mouse sensor") that detects operations such as a user sliding the first mouse 40A on a work surface (a work surface with which the bottom surface of the first mouse 40A is in contact in FIG. 2). The mouse sensor is provided so as to be exposed from an opening 43A provided in the bottom surface of the first mouse 40A, for example. The mouse sensor is a sensor that acquires data for calculating movement (movement direction, movement distance, movement speed, etc.), on the work surface, of the first mouse 40A placed with the bottom surface thereof facing the work surface. The mouse sensor may be, for example, an optical sensor or a laser sensor. As shown in FIG. 2, the first mouse 40A includes a button 41A and a button 42A.

The second mouse 40B includes a mouse sensor that detects operations such as the user sliding the second mouse 40B on the work surface, similar to that with the first mouse 40A. The mouse sensor of the second mouse 40B is provided so as to be exposed from an opening 43B provided in the bottom surface of the second mouse 40B, for example.

Data acquired by the mouse sensor of the first mouse 40A and data acquired by the mouse sensor of the second mouse 40B are repeatedly transmitted to the input device communication unit 24 at appropriate timings. As shown in FIG. 2, the second mouse 40B includes a button 41B and a button 42B. Data indicating operation states of the button 41B and the button 42B are repeatedly transmitted to the input device communication unit 24 at appropriate timings.

The first mouse 40A and the second mouse 40B each include an attitude sensor. Specifically, the first mouse 40A and the second mouse 40B each include an acceleration sensor (not shown) and an angular velocity sensor (not shown). The acceleration sensor detects the magnitudes of accelerations along directions of specified three axes (e.g., x, y, and z axes shown in FIG. 2). The acceleration sensor may detect an acceleration in one axis direction or accelerations in two axis directions. The angular velocity sensor detects angular velocities around the specified three axes (x, y, and z axes shown in FIG. 2). The angular velocity sensor may detect an angular velocity around one axis or angular velocities around two axes. Then, the detection results from the acceleration sensor and the angular velocity sensor are repeatedly transmitted to the input device communication unit 24 at appropriate timings.

As for the attitude sensor, various sensors capable of detecting attitude, such as geomagnetic sensors, may be used, and multiple sensors may be used in combination. A plurality of optical sensors may be combined to be used as the attitude sensor. For example, rotation of each mouse, or the like, may be able to be detected based on the difference in detection values (the difference in movement direction, etc.) of each optical sensor.

The first mouse 40A is provided with a vibration device (not shown) that vibrates the first mouse 40A, and the second mouse 40B is provided with a vibration device (not shown) that vibrates the second mouse 40B.

FIG. 3 illustrates an operation method for the first mouse 40A and the second mouse 40B. As shown in FIG. 3, the user holds the first mouse 40A with the left hand and the second mouse 40B with the right hand. In addition, as shown in FIG. 3, the user can perform an operation of moving the first mouse 40A on the work surface, can press the button 41A with the index finger or middle finger, and can press the button 42A with the thumb. Also, as shown in FIG. 3, the user can perform an operation of moving the second mouse 40B on the work surface, can press the button 41B with the index finger or middle finger, and can press the button 42B with the thumb.

The work surface for the first mouse 40A and the work surface for the second mouse 40B may be different work surfaces rather than a single work surface (a common work surface).

### Processing assumed in exemplary embodiment

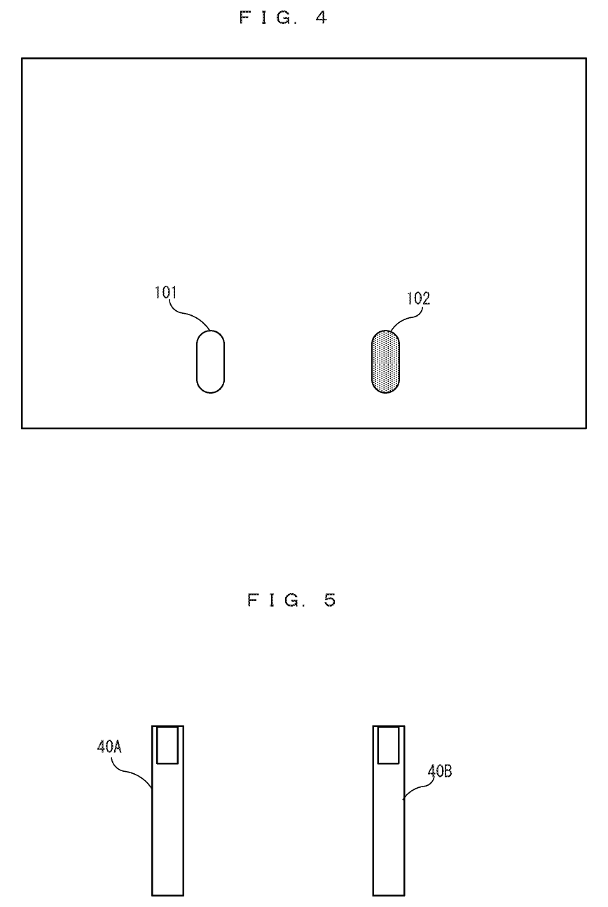

Next, the outline of information processing assumed in the exemplary embodiment will be described. In this exemplary embodiment, game processing is assumed as an example of the information processing. The game processing involves operating two different virtual objects with two mice. FIG. 4 shows an example of a game screen. In FIG. 4, a first object 101 and a second object 102 are shown. The first object 101 and the second object 102 are disposed on a virtual surface, which is a surface formed in a virtual space. The first object 101 and the second object 102 can move on the virtual surface. The virtual surface may not necessarily be visible to the user. The virtual surface may be either a flat surface or a curved surface. The virtual surface may be a surface that can deform like a rippling water surface, for example.

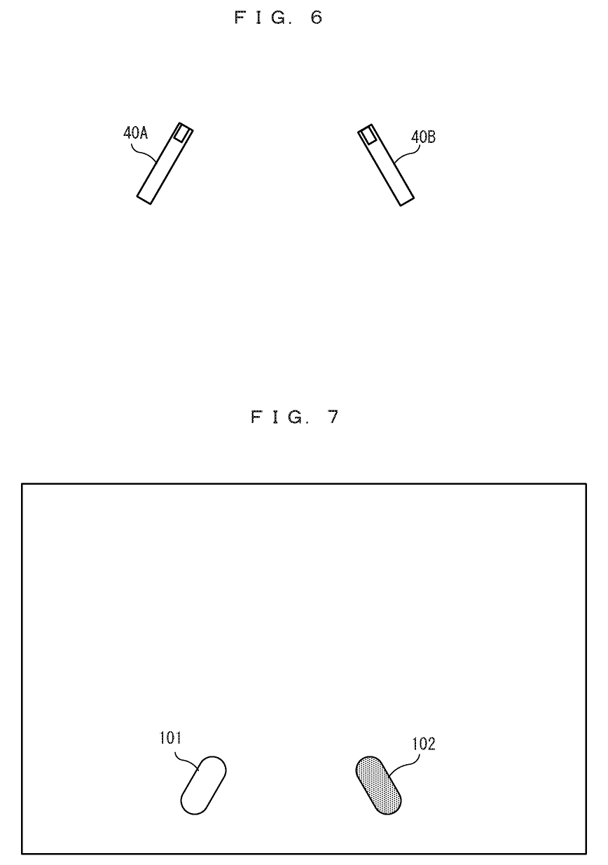

In this game, the first object 101 is operated by the first mouse 40A, and the second object 102 is operated by the second mouse 40B. An example of operation will be described. For example, when starting game processing, the user disposes each mouse in an attitude in which the mouse is vertically long on a specified work surface, as shown in FIG. 5. At this time, the attitude of each mouse is associated with the attitude of a corresponding object as shown in FIG. 4 (the initial attitude at the start of the game), and the game processing is started. During play of the game, the user causes each mouse to translate on the work surface, thereby allowing the object corresponding to the mouse to move on the virtual surface. Regarding the movement of the objects, the movement may be performed in a direction away from the virtual surface temporarily by, for example, jumping in response to a specified button being pressed. By the user rotating each mouse (around the z-axis) on the work surface as shown in FIG. 6, for example, the object corresponding to the mouse can be rotated in accordance with the rotation of the mouse as shown in FIG. 7. The amount of rotation can be determined, for example, based on the difference from the attitude at the start of the game. In this game, a specified process as described later is executed based on the positional relationship between the objects and the attitudes (orientations) of the objects.

Here, in the above game processing, collision detection may be performed between the first object 101 and the second object 102. When the two objects collide, at least one of the objects may be bounced off or blown away. In this case, at least one mouse may be vibrated or a specified sound may be outputted.

Regarding the movement of the first object 101 and the second object 102, the movement manner of the first object 101 in response to a movement operation of the first mouse 40A and the movement manner of the second object 102 in response to that of the second mouse 40B may be different constantly or temporarily. For example, a case where the first object 101 has acquired a speed reduction item that appears in the virtual space is assumed. In this case, even when the first mouse 40A and the second mouse 40B are translated by the same amount, movement control may be performed so that the amount of movement of the first object 101 is less than that of the second object 102.

Furthermore, based on an operation on one mouse, the movement manner of the object corresponding to the other mouse may be changed. For example, when a specified button of the first mouse 40A is pressed or the first object 101 acquires a specific item, control may be performed so that the amount of movement of the second object 102 relative to the amount of operation of the second mouse 40B is different from that in normal time.

In the above game processing, the remaining lives and durability (HP, etc.) of the first object 101 and the second object 102 may be set. In this case, the remaining lives or durability may be managed as a shared matter or may be managed separately. In the case of separate management, control for causing only the first object 101 to reach game over and exit the virtual space may be performed, for example. In this case, the game is continued by operating only the second object 102. For example, assuming game processing in which the first object 101 and the second object 102 can attack independently, if one of the objects reaches game over, play may be continued using only the other object thereafter.

In the description of the game processing described later, it is basically assumed that a single user operates two mice as described above. In this regard, in another exemplary embodiment, game processing in which the two mice are operated by two users, each controlling one, may be executed. For example, the game processing may be executed as cooperative play type game processing. In such a game, each remote user may operate one of the mice in an online play manner. In this case, it may be possible to choose between a play mode in which one person operates two mice and a play mode in which two users each operate one mouse. That is, in the game using two mice, the mode may be selectable between a play mode in which one person uses two mice and a play mode in which two users each operate one mouse. Furthermore, the difficulty or the operation method of the game may be changed depending on the play mode.

The various processes described above may be used in combination with the following game processing that utilizes the intersection of the directions in which the above objects are oriented, or may not necessarily be used in combination. As a matter of course, the various processes described above may be executed in game processing that does not use the following processing.

Next, an example of a specified process based on the positional relationship between the objects and the orientations of the objects will be described. In the exemplary embodiment, as said process, a process that utilizes the intersection of the directions in which (the tips of) the first object 101 and the second object 102 are oriented is executed. In other words, the game exemplified below is a game that is played in such a manner that the user operates each of the first object 101 and the second object 102 with two mice to create an intersection point of the directions in which the objects are oriented. Hereinafter, an example of game processing using the above process will be described in detail. In the description below, the position where the direction in which the first object 101 is oriented and the direction in which the second object 102 is oriented intersect is referred to as an "intersection-point position". The "intersection-point position" may not necessarily be strictly a point, and may be a region. For example, in game processing, thick lines (which may be visible or invisible) may extend from the respective objects in the directions in which the objects are oriented, and a region caused by the intersection thereof may be treated as the intersection-point position.

### Used data example

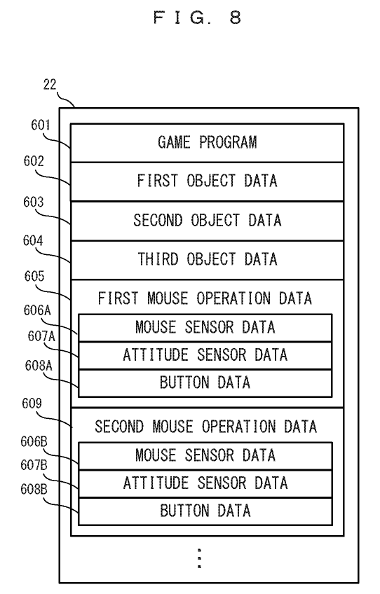

First, various data used in this game processing will be described. FIG. 8 is a memory map showing an example of various data stored in the storage unit 22 of the information processing apparatus 2. In the storage unit 22, a game program 601, first object data 602, second object data 603, third object data 604, first mouse operation data 605, second mouse operation data 609, etc., are stored.

The game program 601 is a program containing computer-executable instructions for executing game processing according to the exemplary embodiment.

The first object data 602 is data about the first object 101. The first object data 602 includes data constituting the appearance of the first object 101, data indicating the position and attitude of the first object 101 on the virtual surface, and data indicating various states of the first object 101 such as the remaining lives and durability of the first object 101.

The second object data 603 is data about the second object 102. The second object data 603 includes various data about the second object 102, similar to the first object data 602.

The third object data 604 is data about various virtual objects other than the first object 101 and the second object 102. For example, the third object data 604 is data about enemy characters.

The first mouse operation data 605 is data indicating the contents of operations performed on the first mouse 40A. The first mouse operation data 605 includes mouse sensor data 606A, attitude sensor data 607A, and button data 608A. The mouse sensor data 606A is data outputted from the mouse sensor of the first mouse 40A. The mouse sensor data 606A includes data indicating the amount of movement and movement direction of the first mouse 40A on the work surface. The attitude sensor data 607A is data outputted from the attitude sensor. In this example, the attitude sensor data 607A includes acceleration data and angular velocity data around the specified three axes. The button data 608A is data indicating the press states of the buttons of the first mouse 40A.

The second mouse operation data 609 is data indicating the contents of operations performed on the second mouse 40B. The second mouse operation data 609 includes mouse sensor data 606B, attitude sensor data 607B, and button data 608B. The mouse sensor data 606B includes data indicating the amount of movement and movement direction of the second mouse 40B on the work surface. The attitude sensor data 607B is data outputted from the attitude sensor of the second mouse 40B. The button data 608B is data indicating the press states of the buttons of the second mouse 40B.

### Flowchart example

Next, an example of a flowchart of this game processing will be described. In the exemplary embodiment, one or more processors read and execute programs stored in one or more memories, whereby the flowchart described below is implemented. The flowchart is merely an example of a processing procedure. Therefore, the processing order of steps may be changed as long as the same result is obtained. In addition, the values of variables and thresholds used in determination steps are also merely examples, and other values may be employed as necessary.

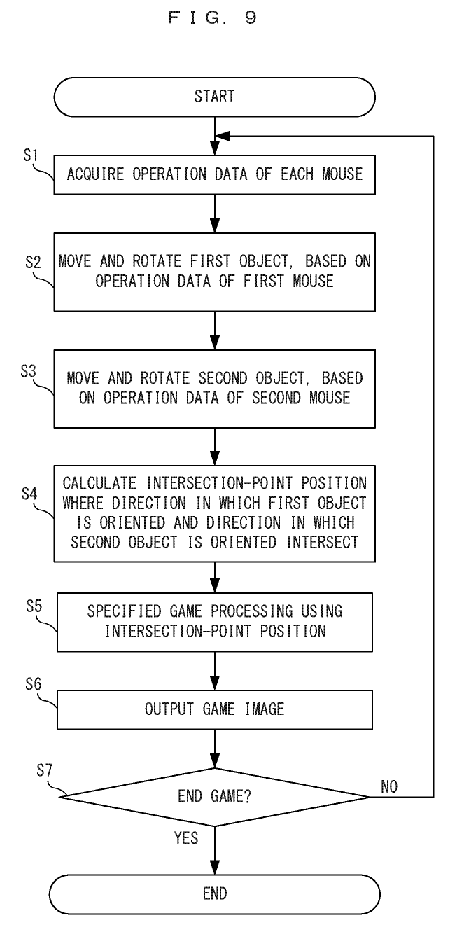

FIG. 9 is a flowchart showing the details of an example of the game processing according to the exemplary embodiment. A processing loop from step S1 to step S7 in FIG. 9 is repeated a plurality of times in one second in accordance with the frame rate.

First, in step S1, the processor 21 acquires the first mouse operation data 605 and the second mouse operation data 609.

Next, in step S2, the processor 21 moves the first object 101 on the virtual surface, based on the mouse sensor data 606A included in the first mouse operation data 605. The processor 21 rotates the first object 101 on the virtual surface, based on the attitude sensor data 607A included in the first mouse operation data 605.

Next, in step S3, the processor 21 moves the second object 102 on the virtual surface, based on the mouse sensor data 606B included in the second mouse operation data 609. The processor 21 rotates the second object 102 on the virtual surface, based on the attitude sensor data 607B included in the second mouse operation data 609.

Next, in step S4, the processor 21 calculates the directions in which the first object 101 and the second object 102 are oriented. Then, the processor 21 calculates the intersection-point position, based on the directions. If there is no intersection-point position, information indicating that no intersection-point position exists is generated.

Next, in step S5, the processor 21 executes specified game processing, based on the intersection-point position. The game processing can also include a process that is performed when the intersection-point position has not been calculated. Specific examples of the specified game processing will be described later.

Next, in step S6, the processor 21 generates a game image reflecting the specified game processing and outputs the resulting image to the display unit 30.

Next, in step S7, the processor 21 determines whether or not a specified game end condition is satisfied. If the game end condition is not satisfied (NO in step S7), the process returns to step S1, and is repeated. If the game end condition is satisfied (YES in step S7), the processor 21 ends the game processing.

This is the end of the description of the flowchart example of the game processing according to the exemplary embodiment.

Next, a specific example of the specified game processing that can be executed in step S5 is shown.

### First Example

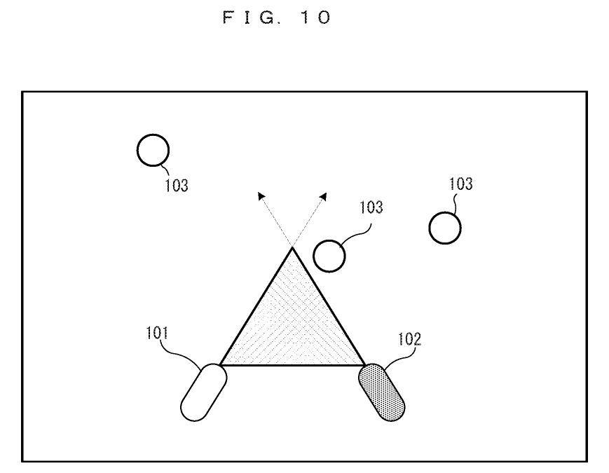

First, as the first example, game processing based on a triangle region will be described. FIG. 10 shows an example of a game screen using the triangle region. In FIG. 10, the orientations of the first object 101 and the second object 102 are indicated by dotted line arrows. The dotted line arrows are indicated for explanatory convenience and are not displayed on the screen. In FIG. 10, a third object 103 is also indicated. In FIG. 10, a triangle region is displayed with the intersection-point position used as one of the vertices thereof, and the tip position of the first object 101 and the tip position of the second object 102 as the other vertices. The positions of the vertices other than the intersection-point position are not limited to the tip positions of the respective objects. For example, other positions such as the midpoint positions of the objects can also be used as vertices.

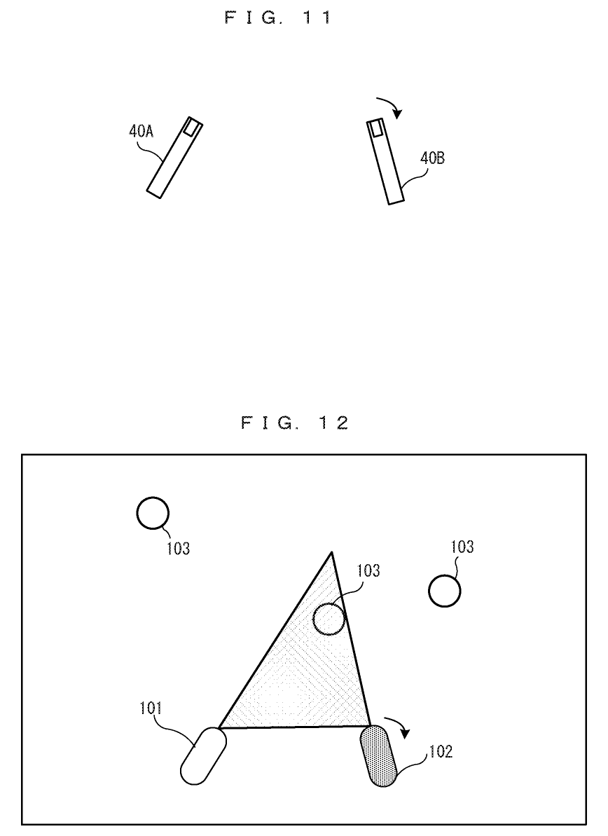

Here, in such a state as the screen example shown in FIG. 10, it is assumed that the attitude of the mouse 40 is the attitude as shown in FIG. 6. In this case, when the second mouse 40B is rotated clockwise as shown in FIG. 11, for example, the orientation of the second object 102 is changed as shown in FIG. 12. As a result, the positions of the vertices of the triangle are also changed. Consequently, the intersection-point position can be changed, and the position, shape, and area of the triangle can be changed. In other words, the user can change the shape, position, and area of the triangle by operating the two mice 40. FIG. 12 also shows the state of being able to contain one of the third objects 103 in the triangle region. This game utilizes such a triangle region. Specifically, in this game, a first process of providing an advantageous effect for the user in the triangle region is executed. For example, a game in which one or more enemy characters that can move on the virtual surface appear in the virtual space as the third object 103 is assumed. In the above game, an example of the first process includes inflicting damage on (attacking) an enemy character contained in the triangle region. At this time, collision detection processing between the first object 101, the second object 102, and the enemy character may be performed. When collision with the enemy character has occurred, a second process of providing an in-game disadvantageous effect may be executed. For example, the disadvantageous effect in the second process involves the first object 101 or the second object 102 receiving damage, losing lives, reaching game over, etc. Thus, performing an operation of causing the enemy character to be contained in the triangle region while avoiding collision with the enemy character is necessary, thus enabling provision of novel unprecedented game characteristics. Furthermore, the enemy character may fire a fourth object such as a bullet. If the fourth object collides with the first object 101 or the second object 102, a process of causing the first object 101 or the second object 102 to receive damage may be also performed. The fourth object may be inhibited from being deleted or the like even when the fourth object is contained in the triangle region. That is, the first process may not necessarily be applied to the fourth object. In the game in which an item appears as the third object 103, another example of the first process is a process of acquiring the item by causing the third object to be contained in the triangle region. Still another example thereof is a process of strengthening an ally character, which is an example of the third object 103, by causing the ally character to be contained in the triangle region.

The condition for executing the first process may be that the intersection-point position is within a specified distance from each of the first object 101 and the second object 102 (i.e., being relatively close).

The effect amount of the first process may be changed in accordance with the time during which the third object 103 is contained in the triangle region or the area size of the triangle region. As an example of changing the effect amount in accordance with the time, in the game in which an attack is performed with the enemy character contained in the triangle region, control may be performed so that damage is inflicted only if the enemy character is contained for a specified time or longer. In addition, control for continuously inflicting damage on the enemy character for the time during which the enemy character is contained in the triangle region may be performed, for example. In other words, control may be performed so that the obtained effect amount is increased as the time during which the third object 103 is contained in the triangle region increases, as compared to a case where said time is shorter. As an example of changing the effect amount in accordance with the area size, in the same game as the above in which an attack is performed with the enemy character contained in the triangle region, control may be performed so that the amount of damage inflicted per unit time increases as the area of the triangle decreases. In this case, although there are a risk of becoming more susceptible to receiving damage due to being closer to the enemy character and a risk in which the enemy character more easily leaves the triangle region, the return of being able to inflict significant damage can be provided. In other words, a game characteristic of high risk and high return can be incorporated, thus enhancing the entertainment characteristics of the game.

A third process of providing a third effect serving as an advantageous effect different from the effect of the first process, on a straight line connecting the first object 101 and the second object 102, may be executed. For example, when a positional relationship in which the enemy character is sandwiched between the first object 101 and the second object 102 is established, a type of attack different from the attack processing of the first process may be performed. For example, an attack using a different weapon or a different attack method may be performed. When this process is also performed, the user can be encouraged to consider the positioning of the first object 101 and the second object 102, thus enhancing the strategic and entertainment characteristics of the game. Being on the straight line connecting the first object 101 and the second object 102 may not necessarily refer to strictly being on the straight line, but the expression may refer to being contained in a region having a thickness and connecting the two objects.

The condition for executing the specified process (the first process, the third process) may be that specified buttons of the respective mice are pressed. A plurality of types of processes may be executed by pressing a specified button, or different processes may require different buttons to be pressed.

Accordingly, when the game based on the triangle region is executed, it is possible to provide a novel game exhibiting an unprecedented operational feel of adjusting the positions and angles of both hands (two mice) on the work surface.

### Second Example

Next, as a second example, an example of game processing that more directly uses the position where the orientations of the first object 101 and the second object 102 intersect will be described. This process is, so to speak, game processing that uses the intersection of the orientations of the first object 101 and the second object 102 as a "pointer" for indicating a specified position. In addition, in this game processing, the first process of providing the advantageous effect for the user as described above is applied only to the intersection-point position.

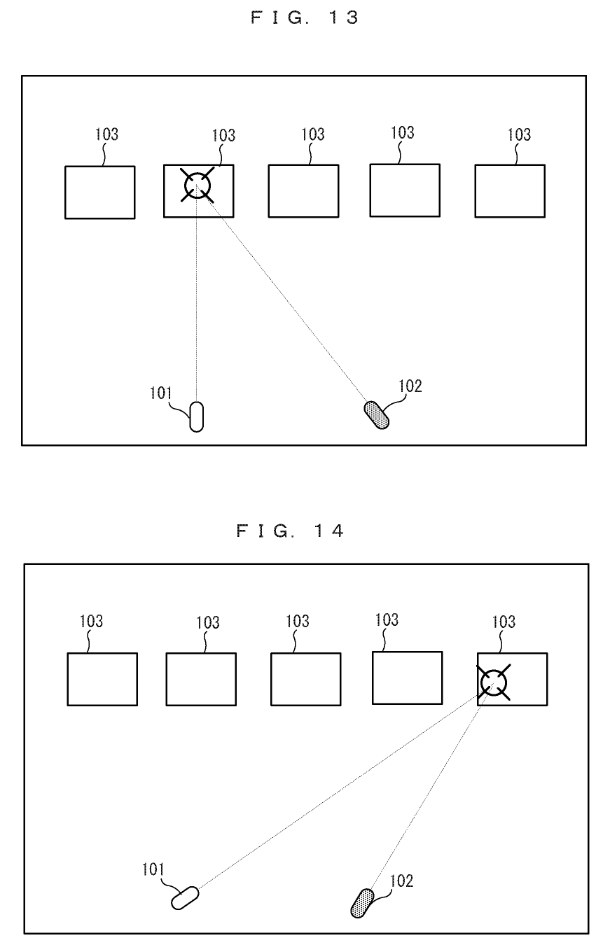

A processing example in the second example includes the following processing. For example, as shown in FIG. 13 and FIG. 14, a plurality of the third objects 103 are displayed, and any one of the objects can be designated (selected) by using the intersection-point position. In addition, there is a process of attacking the third object 103 at the intersection-point position. In FIG. 13 and FIG. 14, examples in which a "crosshair" is displayed so as to make the user easily understand the intersection-point position are shown. However, the form of not displaying the "crosshair" may be used.

A process of lifting the third object 103 located at the intersection-point position and moving the object to a different position may be performed, for example. As one specific example, game processing of operating two rod-shaped objects by using two mice, pinching and lifting the third object by the rod-shaped objects, and moving the third object to a different position may be performed. In addition to the above, in a puzzle game in which pieces fall from above, a process of deleting a piece or the like at the intersection-point position may be performed. In this type of a puzzle game, the movement directions of the first object 101 and the second object 102 may be restricted to movement only in a specified direction. For example, the game may be configured such that the first object 101 and the second object 102 can move only horizontally below the region on which the pieces fall.

In the second example, the condition for executing the first process may be that the intersection-point position is within a specified distance from each of the first object 101 and the second object 102.

In the second example, control for changing the effect amount of the first process in accordance with the time during which the intersection-point position is indicated may be performed. For example, control may be performed so that the further advantageous effect, such as inflicting more damage, is provided as the time in which the enemy character and the intersection-point position overlap each other increases.

The process of providing the specified effect at the intersection-point position described in the second example may be used in combination with the first example described above. For example, in such a game described above where an enemy character appears in the virtual space, it may be allowed to utilize three types of attack methods, namely, a first attack method (the first process in the first example) of attacking the enemy character contained in the triangle region, a second attack method (the third process) of attacking the enemy character having the positional relationship of being sandwiched between the first object 101 and the second object 102, and a third attack method (a fourth process different from the first process) of attacking the enemy character located at the intersection-point position. In this case, the execution conditions for the first process, the third process, and the fourth process may be that the specified buttons as described above are pressed.

Accordingly, the game processing using the process that directly imparts an effect on the intersection-point position can also provide a game exhibiting a novel operational feel using two mice.

### Third Example

Next, a third example will be described. As the third example, an example of game processing that executes a specified process, based on a "timing" at which the orientation of the first object 101 and the orientation of the second object 102 intersect will be described. For example, a game of operating a player character holding, in both hands, two swords corresponding to the first object 101 and the second object 102 is assumed. The game screen may be a screen on which the back side of the player character is displayed or only two swords are displayed, for example. In addition, the game processing involves, at a timing of a sword being brought down from above by an enemy character displayed on the deep side of the screen, crossing the two swords to cause the orientations of two mice to intersect, thereby defending against the attack, thus enabling defense against the attack from the enemy character. In this process, regardless of where the intersection-point position is to be located, the defense processing is executed based on the timing of creating the intersection point.

### Modifications

In the above exemplary embodiment, each mouse sensor detects the movement of a corresponding mouse and outputs the movement direction, the amount of movement, etc. In another exemplary embodiment, the mouse sensor may output only data about reflected light from the work surface, and the information processing apparatus 2 may output whether the mouse has moved, the movement direction, the amount of movement, etc., based on the data. In the above exemplary embodiment, the information processing apparatus 2 calculates the current position of each mouse in a mouse coordinate system. However, the mouse sensor may calculate the current position of the corresponding mouse and send data related thereto the information processing apparatus 2. In addition, the information processing apparatus 2 and the mouse sensor may not necessarily calculate the current position of the mouse. The same applies to the attitude sensor, and the calculation of the actual attitude may be performed by either the information processing apparatus 2 or the mouse.

The shape of the mouse 40 in the above exemplary embodiment is an example. For example, the mouse may include a grip for allowing easy holding and lifting by the user. As an example, the mouse may be used as a typical game controller. That is, a game controller having a mouse sensor is included in the range of the mouse in the present disclosure. In addition, the mouse may be attachable to/detachable from another apparatus.

The above-described game may be a game with a top-down perspective view looking vertically down on the ground surface (virtual surface), or may be a game with a diagonally looking down view (which may be also referred to as a quarter view). The game may be one in which a virtual camera captures the forward direction, and the first object 101 and the second object 102 move upward, downward, leftward, and rightward on the screen.

Two mice are used in the above exemplary embodiment, but three or more mice may be used. At this time, processing similar to the above may be executed by specific or non-specific two mice among the three or more mice, or processing similar to the above may be executed by the three or more mice.

In the above exemplary embodiment, the mice may be vibrated in accordance with the area size of the triangle region or the intersection-point position. For example, the mice may vibrate more as the triangle region increases. In addition, for example, the mice may vibrate more as the intersection-point position becomes closer to the first object 101 and the second object 102. Furthermore, out of the first object 101 and the second object 102, the mouse corresponding to the object closer to the intersection-point position may vibrate more than the other mouse, for example. That is, in accordance with the position indicated by each of the two mice, the vibration of each of the two mice may be controlled (including not to vibrate). For example, the vibration may be controlled in accordance with the respective positions of the objects operated by the two mice, the vibration of the two mice may be controlled in accordance with one position on the screen indicated by the two objects operated by the two mice, or the vibration of the two mice may be controlled in accordance with the positions of the two objects operated by the two mice and one position on the screen indicated by the objects. As an example, the one position on the screen indicated by the two objects operated by the two mice may be the intersection-point position toward which the objects respectively operated by the two mice are oriented, or the position where the objects overlap each other. As an example, the magnitudes and frequencies of the vibration of the two mice may be changed in accordance with the change of the positions indicated by the two mice. Such vibration control may also be applied to games other than the game described in the above exemplary embodiment, as well as in fields other than games. In addition, three or more mice may be used.

In the above exemplary embodiment, the case where the game processing described above is executed by a single information processing apparatus 2 has been described. The information processing apparatus 2 may include a plurality of storages and processors. In addition, the game processing may be executed in a shared manner by the storages and processors. The information processing apparatus may be a server, and the game processing may be executed in a distributed system composed of a plurality of information processing apparatuses including the server.

### INDUSTRIAL APPLICABILITY

The game processing method, the game program, and the game system according to the present disclosure can provide novel game processing using a mouse.

What is claimed is:

1. A computer-implemented method, comprising:
moving a first object on a virtual surface in a virtual space, based on first data outputted in accordance with movement of a first mouse on a surface;
rotating the first object, based on second data outputted in accordance with rotation of the first mouse;
moving a second object on the virtual surface in the virtual space, based on third data outputted in accordance with movement of a second mouse on the surface;
rotating the second object, based on fourth data outputted in accordance with rotation of the second mouse; and
executing a first process, based on an intersection point where a direction in which the first object is oriented and a direction in which the second object is oriented intersect.

2. The computer-implemented method according to claim 1, wherein the first process is a process based on a triangle region formed, on the virtual surface, from a position of the first object, a position of the second object, and the intersection point.

3. The computer-implemented method according to claim 2, wherein the first process is a process of providing a first effect serving as an in-game advantageous effect in the triangle region.

4. The computer-implemented method according to claim 3, comprising
moving a third object on the virtual surface, wherein
the first effect is an effect on the third object in a state of being contained in the triangle region.

5. The computer-implemented method according to claim 4, wherein, when the first object or the second object and the third object are in a specified positional relationship, a second process of providing a second effect serving as an in-game disadvantageous effect is executed.

6. The computer-implemented method according to claim 4, wherein, in the first process, an effect amount of the first effect is increased as a time during which the third object is contained in the triangle region increases.

7. The computer-implemented method according to claim 5, wherein, in the first process, an effect amount of the first effect increases as an area of the triangle decreases.

8. The computer-implemented method according to claim 1, wherein a third process of providing a third effect serving as an in-game advantageous effect, on a straight line connecting the first object and the second object, is executed.

9. The computer-implemented method according to claim 2, wherein a fourth process of providing a fourth effect serving as an in-game advantageous effect, at the intersection point, is executed.

10. The computer-implemented method according to claim 1, wherein the first process is a process of providing a fifth effect serving as an in-game advantageous effect, at the intersection point.

11. One or more non-transitory computer-readable storage media having stored therein instructions that cause one or more processors to perform operations comprising:
moving a first object on a virtual surface in a virtual space, based on first data outputted in accordance with movement of a first mouse on a surface;
rotating the first object, based on second data outputted in accordance with rotation of the first mouse;
moving a second object on the virtual surface in the virtual space, based on third data outputted in accordance with movement of a second mouse on the surface;
rotating the second object, based on fourth data outputted in accordance with rotation of the second mouse; and
executing a first process, based on an intersection point where a direction in which the first object is oriented and a direction in which the second object is oriented intersect.

12. The one or more non-transitory computer-readable storage media according to claim 11, wherein the first process is a process of providing a first effect serving as an in-game advantageous effect in the triangle region.

13. The one or more non-transitory computer-readable storage media according to claim 12, wherein the first process is a process based on a triangle region formed, on the virtual surface, from a position of the first object, a position of the second object, and the intersection point.

14. The one or more non-transitory computer-readable storage media according to claim 13, wherein
the operations comprise moving a third object on the virtual surface, and
the first effect is an effect on the third object in a state of being contained in the triangle region.

15. The one or more non-transitory computer-readable storage media according to claim 14, wherein, in the first process, an effect amount of the first effect is increased as a time during which the third object is contained in the triangle region increases.

16. A game system comprising:
mice having an optical sensor and an attitude sensor;
one or more processors; and
one or more memories storing instructions that cause the one or more processors to perform operations comprising
moving a first object on a virtual surface in a virtual space, based on first data outputted in accordance with movement of a first mouse on a surface,
rotating the first object, based on second data outputted in accordance with rotation of the first mouse,
moving a second object on the virtual surface in the virtual space, based on third data outputted in accordance with movement of a second mouse on the surface,
rotating the second object, based on fourth data outputted in accordance with rotation of the second mouse, and
executing a first process, based on an intersection point where a direction in which the first object is oriented and a direction in which the second object is oriented intersect.

17. The game system according to claim 16, wherein the first process is a process of providing a first effect serving as an in-game advantageous effect in the triangle region.

18. The game system according to claim 17, wherein the first process is a process based on a triangle region formed, on the virtual surface, from a position of the first object, a position of the second object, and the intersection point.

19. The game system according to claim 18, wherein
the operations comprise moving a third object on the virtual surface, and
the first effect is an effect on the third object in a state of being contained in the triangle region.

20. The game system according to claim 19, wherein, in the first process, an effect amount of the first effect increases as a time during which the third object is contained in the triangle region increases.
